(19) United States
(12) Patent Application Publication
(10) Pub. No.: US 2025/0358296 A1
(43) Pub. Date: Nov. 20, 2025

(54) CYBERSECURITY THREAT DETECTION AND MITIGATION CLASSIFICATION SYSTEM

(71) Applicant: Arctic Wolf Networks, Inc., Eden Prairie, MN (US)

(72) Inventors: Kenneth D. Ray, Enumclaw, WA (US); Michael Elliott Mylrea, Delray Beach, FL (US); Marcio Lopes Larroyd, Kitchener (CA); Zaahid Muhammad, Minneapolis, MN (US); Warren Christopher Gray, Kitchener (CA); Brian Wilson Boon, Lincoln, NE (US)

(21) Appl. No.: 19/206,239

(22) Filed: May 13, 2025

Related U.S. Application Data
(60) Provisional application No. 63/647,320, filed on May 14, 2024.

(51) Int. Cl. H04L 9/40; G06F 21/56; H04L 41/16

(52) U.S. Cl. CPC H04L 63/1416; G06F 21/568; H04L 41/16

(57) ABSTRACT

In some implementations, a cybersecurity threat detection and mitigation system is provided. The system refines an artificial intelligence (AI) model with a corpus of historical data that represents security events that occurred, queries that were submitted by security analysts in response to the security events, and actions that were performed for mitigating the security events. Telemetry data that corresponds to behavior and performance of a computer network is collected and provided to the AI model. Based on the telemetry data, the AI model predicts a potential security threat to the computer network and performs an assessment of risk to the computer network. When the assessment of risk to the computer network indicates that the potential security threat is an actual security threat, a security alert that corresponds to the actual security threat is triggered. Other embodiments are described and claimed.

### CROSS-REFERENCE TO RELATED APPLICATION

This application claims priority to U.S. Provisional Application Ser. No. 63/647,320, filed May 14, 2024, the entire disclosure of which is hereby incorporated by reference.

### TECHNICAL FIELD

This specification generally relates to cybersecurity threat detection and mitigation classification, using artificial-intelligence-based techniques.

### BACKGROUND

Cybersecurity involves the protection of systems, networks, and programs from digital attacks. Such digital attacks (also referred to as cyberattacks) are generally directed to accessing, changing, or destroying sensitive information, or otherwise interrupting operational processes. Various cybersecurity platforms have been implemented to monitor computer networks and devices, to detect potential cyberattacks and other threats, and to facilitate the performance appropriate response actions.

Typical cybersecurity systems employ signature-based detection to provide a reactive, rules-based system. For example, current systems may rely on static embeddings and predefined rules operating in isolated security silos. Accordingly, current systems may not be capable of establishing causal relationships in attack chains, may not adapt to organization-specific security postures, and may include limited learning from historical remediation outputs.

Typical cybersecurity platforms generate security logs and events. Many platforms generate data in proprietary formats and/or data models. Certain platforms may support common data formats or models, such as the Open Cybersecurity Schema Framework (OCSF). Drafting queries against typical cybersecurity platforms has traditionally been difficult, for example due to non-standard data models and formats, and due to the reactive, rules-based nature of the detection system.

### SUMMARY

This document generally describes computer systems, processes, products, and devices for cybersecurity threat detection and mitigation classification, using artificial intelligence (AI) based techniques. The technology described in this document can incorporate an AI Retrieval Augmented Generation (RAG) architecture, and can be optimized by reinforcement learning and human feedback (RLHF). Further, security case context can be improved through dynamic and continuous classification and optimization.

In general, cyber defenses may be challenged by adversaries that are increasingly complex, non-linear, and evolving. The presently described technology includes techniques for identifying, classifying, and protecting against security threats, vulnerabilities, and indicators of attack (IoA), including the performance of real-time curated queries and actions for responding to detections. Curated queries may include an optimal set of responses or actions given an improved classification of an evidence task, based on cause and effect of historic actions. For example, as described herein, an optimal set of actions to improve resolution and customer outcomes may be learned based on a historical corpus of responses performed by security analysts. A curated query may codify those set of actions, and may continually learn from historic data. Actions for responding to detection may include events, alerts, threats, and other actions. Accordingly, the system disclosed herein may learn optimal paths for resolution from previous mitigations, including actions taken to reduce or prevent the impact of potential or actual security threats.

The curated queries and actions can become increasingly proactive and predictive over time. Such techniques can include artificial intelligence (AI) and/or machine learning (ML) data classification, training, tuning, and reinforcement learning techniques. In addition, the techniques can include filtering classifications based on value-added actions taken, as well as value at risk, risk levels, and criticality. Further, derived information can be continuously generated for targeted security improvements.

The artificial intelligence (AI) based techniques can be used to improve classification of event types (e.g., threats, vulnerabilities, indicators of attack/comprise, etc.) and optimal sets of actions to take in response. To achieve that goal, the AI-based techniques can leverage value-added logic from historical data (e.g., queries and actions taken that corresponded to different alert, event, and/or case types). The logic can be translated into curated queries and actions that define the optimal path for response. Further, the logic can be codified in an AI model that is configured to predict which query should be submitted along with an associated set of actions for a case. As the classification system is used (e.g., by security analysts or another sort of system operator), value-driven models weights (or vectored embeddings) that underpin the system can be strengthened via reinforcement learning human feedback loops, improving performance of the AI model.

In some implementations, a cybersecurity threat detection and mitigation system can be configured to perform operations including refining an artificial intelligence (AI) model with a corpus of historical security data that represents security events that occurred across a computer network, queries that were submitted by security analysts in response to the security events, and actions that were performed for mitigating the security events; collecting real-time telemetry data that corresponds to behavior and performance of the computer network; providing the real-time telemetry data to the AI model; analyzing, by the AI model, the real-time telemetry data in conjunction with the historical security data to identify a potential security threat to the computer network using multi-dimensional vector representations that encode threat characteristics, network behaviors, and mitigation effectiveness in interconnected subspaces; performing, by the AI model, an assessment of risk to the computer network for the potential security threat; and when the assessment of risk to the computer network indicates that the potential security threat is an actual security threat, triggering a security alert that corresponds to the actual security threat.

Other implementations of this aspect include corresponding computer methods, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The assessment of risk to the computer network can include determining a risk value that corresponds to the potential security threat. The potential security threat can be indicated as an actual security threat when the determined risk value meets a threshold value. The operations can further include dynamically adjusting the threshold value based on network conditions and threat intelligence feeds through a continuous Bayesian optimization process incorporating time-decay functions for aging intelligence. The operations can further include, when the assessment of risk to the computer network indicates that the potential security threat is an actual security threat, determining, by the AI model, at least one automated mitigation action based on a type of the actual security threat and initiating the at least one automated mitigation action. The operations can further include predicting, by the AI model, at least one query for investigating the actual security threat by translating detection signals into investigation pathways, and providing the predicted at least one query for presentation to a security analyst through a user interface. The operations can further include receiving, through the user interface, a selection of the at least one query; executing the at least one query, and returning a result based on the executing for presentation through the user interface; providing, to the AI model, query selection data that indicates that the at least one question was selected; receiving, through the user interface, a feedback response from the security analyst indicative of effectiveness of mitigation actions taken in response to the query results; and incrementally refining the AI model based on the query selection data and the effectiveness of mitigation actions taken in response to the query results through Reinforcement Learning from Human Feedback (RLHF). The operations can further include incrementally refining the AI model with a dual feedback loop combining the Reinforcement Learning from Human Feedback (RLHF) with Reinforcement Learning from AI Feedback (RLAIF). Refining the AI model can include automatically restructuring a vector index for the multi-dimensional vector representations. The operations can further include prioritizing the security alert based on a potential impact of the potential security threat on an organization that operates the security network, a detection confidence that corresponds to a likelihood that the security alert is not a false positive or a false negative, and the potential lateral movement paths available to the threat actor based on network topology analysis. Collecting the real-time telemetry data can include receiving the real-time telemetry data through multiple different security threat feeds, each security threat feed having a different data format and outputting the real-time data in a common schema with standardized metadata tagging for cross-correlation across different data sources. The operations can further include, in response to the security alert being an indicator of attack, issuing a ticket that corresponds to the actual security threat, by a ticketing system that is integrated with the cybersecurity threat detection and mitigation system; and automatically assigning the ticket to an appropriate security team based on a threat classification and team expertise.

The systems, devices, program products, and processes described throughout this document can, in some instances, provide one or more of the following advantages. A security posture can be enhanced by accurately identifying, classifying, prioritizing, and mitigating cybersecurity threats and vulnerabilities. By continuously incorporating feedback and performing fine tuning processes, a knowledge base can be configured for improved explainability. Further, critical alerts can be prioritized based on various factors, and alert fatigue can be reduced by filtering out false positives and low-risk alerts. By incorporating the filtering of classifications, as well as generating recommendations for mitigations and optimizations, the ability of an artificial intelligence (AI) model to perform in real-time and to provide more proactive defense can be enhanced. Further, leveraging AI techniques such as vectorized embeddings can enhance workflow efficiency, enabling faster and more accurate analysis of detection attributes.

Other features, aspects and potential advantages will be apparent from the accompanying description and figures.

### DESCRIPTION OF DRAWINGS

FIG. 1 depicts an example retrieval augmented generation (RAG) platform and an example process flow for generating responses based on user input.

FIG. 2 depicts an example process flow for generating responses based on user input.

FIG. 3 depicts an example decision tree for classifying tasks, based on data features of the tasks.

FIG. 4 depicts an example process flow for training an artificial intelligence (AI) model, including a continuous feedback loop.

FIG. 5 depicts an example process flow for using human augmented reinforcement learning to fine tune model detection classifications.

FIG. 6 depicts an example schema of an open cybersecurity schema framework (OCSF) to improve data standardization and classification context of an AI model.

FIG. 7 depicts an example process flow for incorporating automation and a unified schema for classifying detections.

FIG. 8 is a schematic diagram that shows an example of a computing system.

Like reference symbols in the various drawings indicate like elements.

### DETAILED DESCRIPTION

This document describes technology that can perform cybersecurity threat detection and mitigation classification, using artificial intelligence (AI) based techniques. In general, security analysts of an organization often tend to operate reactively. Even well-resourced organizations with unique sets of security data and monitoring may lack context and understanding of the relationship of the data being communicated over the organization's network. Thus, the data may not be actionable in a proactive way. The AI-driven cybersecurity threat detection and mitigation classifier system described herein can help solve these problems. By integrating advanced machine learning techniques, reinforcement learning frameworks, and human feedback integration, the AI-driven system can provide a proactive and adaptive approach to cybersecurity.

In addition to classifying threats, the AI-driven system can use an AI model to generate derived information, such as recommendations for mitigations and optimizations to improve automated rules. Recommended mitigations may include actions taken to reduce or prevent the impact of potential or actual security threats. These recommendations can be based on the identified threats, their criticality, and risk levels, as well as best practices and known effective countermeasures. The AI model can generate the recommendation, for example, based at least in part on an indicator of attack (IoA) and a value at risk (e.g., as defined by rules and weights in the algorithm), and can be continuously improved. Through continuous learning from human feedback, historical data, and real-time observations, for example, the AI model can iteratively update its classification algorithms and recommendation engines. The AI model can adapt to evolving threats and cybersecurity requirements, by refining its ability to accurately identify threats, prioritizing alerts, and providing actionable recommendations.

By incorporating the filtering of classifications, as well as generating recommendations for mitigations and optimizations, the AI-driven system can enhance the ability of the cybersecurity system to perform in real-time and to provide more proactive defense. Thus, risk reduction performance can be improved while reducing cost for organizations. Such organizations can thereby prioritize their response efforts, allocate resources efficiently, and proactively strengthen their security posture against emerging threats. After a case or a set of actions is taken by security analysts, for example, control logic or a set of decision tree actions can be illuminated; providing logic to guide and/or automate a cybersecurity response workflow. An understanding of the optimal set of actions for responding to particular security events, alerts, attacks, threats, etc., can be classified in the logic and weights of the AI model, thereby enabling curated queries and actions. Security analysts can be provided with an ability to map the optimal path for completion based on query and action classifier logic that underpins the AI model. The AI model can continue to improve as those queries and actions are reaffirmed over time.

Accordingly, the AI-driven system invention represents a significant advancement over traditional cybersecurity approaches by fundamentally reimagining threat detection as a proactive, AI-driven process rather than a reactive, rules-based system. The novel integration of historical security data with real-time telemetry creates a continuous learning loop that enables the system to not only identify known threat patterns but also detect emerging threats that would evade conventional signature-based systems. Unlike previous approaches that operate in isolated security silos, this system leverages a unified AI architecture that correlates diverse data sources through standardized schemas, enabling cross-domain threat analysis that was previously impossible.

Modern cybersecurity challenges have evolved beyond traditional signature-based detection, requiring systems that can understand context, behavior, and intent. While existing AI approaches often rely on static embeddings and predefined rules, they fail to capture the complex temporal relationships between security events or adapt to the rapidly changing threat landscape. In contrast, the present disclosure presents a novel approach combining adaptive semantic vectorization, context-aware model orchestration, and continuous reinforcement learning. Accordingly, compared to current solutions, the present disclosure may (1) establish true causal relationships in attack chains, (2) provide good adaptation to organization-specific security postures, and (3) enable learning from historical remediation outcomes.

What makes the disclosed approach particularly innovative is its human-AI collaborative framework, where security analyst feedback and query interactions are systematically incorporated into the model's continual learning process. As described further below, the use of vectorized embeddings in a retrieval augmented generation (RAG) knowledge base for analyst feedback represents a step-change in how institutional security knowledge is captured and operationalized. Furthermore, the system's ability to dynamically adjust risk thresholds based on network conditions and implement automated mitigation actions creates an adaptive security posture that evolves with the threat landscape. This symbiotic relationship between automated detection and human expertise, coupled with explainable AI capabilities and digital twin simulation, establishes a new paradigm in cybersecurity that transcends the limitations of static rule-based systems and manual threat hunting approaches.

As described further below, the disclosed system provides unprecedented integration of Reinforcement Learning from Human Feedback (RLHF) and Reinforcement Learning from AI Feedback (RLAIF) in the cybersecurity domain. While traditional security systems might use one approach in isolation, the present disclosure creates a dual-feedback loop in which analyst responses (RLHF) are captured through the query selection and threat classification validation interfaces, while simultaneously leveraging automated AI agents (RLAIF) that continuously evaluate model performance against simulated attacks in the digital twin environment. This hybrid reinforcement learning architecture enables the system to benefit from both human domain expertise and the scalability of AI-driven evaluation, creating a self-improving defense mechanism that becomes increasingly resilient to adversarial techniques. The novel combination of these complementary learning approaches, specifically tailored for cybersecurity applications with appropriate confidence scoring and explainability layers, represents a significant technological advancement that is not present in existing threat detection platforms.

In some implementations, an AI virtual concierge platform can be used as a front end to the AI-driven cybersecurity threat detection and mitigation classifier system. The virtual concierge platform, for example, can optimize the performance of security operations (e.g., people, processes, and technology) via human-augmented AI model enrichment, automation, and intelligence. For example, a dynamic chatbot interface of the virtual concierge platform can facilitate continuous improvement of the AI model through reinforcement learning from security analysts, who can assess the quality of outputs from the AI model. This continuously informs and improves the optimal path or set of actions needed to respond to an event, alert, ticket, etc. The dynamic chatbot interface can also enable customers (e.g., non-specialist consumers of security information and services provided by a computer security platform) to self-service, perform analysis, summarize a text, etc., from a single dynamic interface.

In general, the AI virtual concierge platform can be used to detect the intent of a question (e.g., a problem an analyst or customer is trying to solve), and to generate an answer to the question. Detecting the “intent” of a question may be performed by clustering of the data, for example by examining historic data of cybersecurity cases and the cause and effect of each action taken to resolve the corresponding cybersecurity case. Based on understanding this cause and effect, and the statistical rule that governs that data distribution, the AI platform may select optimal steps based on that “intent” of the data. When provided with a question (e.g., via a prompt), for example, the virtual concierge platform can recognize the intent of the question, can dynamically curate or recommend questions or prompts, and can suggest an answer for an optimal response. By generating dynamically curated questions or prompts, the AI platform may emulate the steps taken by a domain expert completing a process. Additionally, instead of taking time and resources, the disclosed system automates much of this process, and may provide a domain expert with an optimal question or answer given the evidence task. This novel approach is not only about clustering and understanding patterns but understanding the rules that govern that data distribution and codifying them and automating them as a set of actions or questions that automatically appear based on the “intent” or meaning of the security event or alert. Platform users can create these rules or can use suggested curated queries, prompts and templates set up through the platform. As users confirm that the platform's assessment of the intent of the prompt/query was correct, for example, its transformer-based model can continuously improve its ability to predict and generate an optimal response. Automation processes can continuously be informed by domain experts and knowledge bases (e.g., historical ticketing data, common recommendations for a particular event and related curated queries, runbooks, templates, etc.).

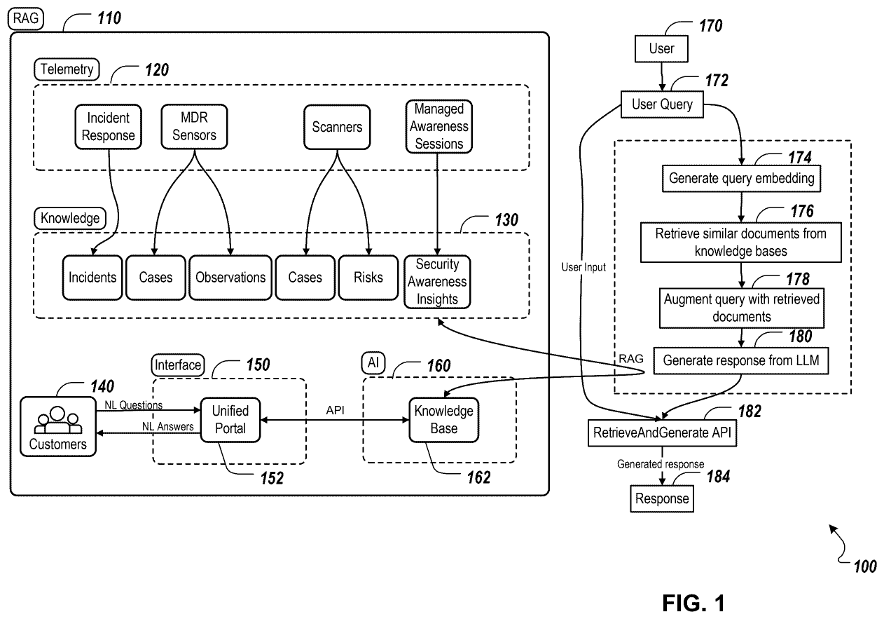

Referring to FIG. 1, an example retrieval augmented generation (RAG) platform 110 and an example process flow 100 for generating responses based on user input are shown. In general, retrieval augmented generation is a technique for enhancing the accuracy and reliability of generative artificial intelligence (AI) models with data retrieved from one or more external sources. For example, large language models (LLMs) can be used to respond to human queries; however, the LLMs may lack specific knowledge about specific topics that are relevant to the queries. Thus, RAG-based techniques can be used to fill in possible gaps in responses generated by the LLMs, and to provide citable sources for details included in the responses-thus, providing users with a degree of transparency and verifiability that may not exist with LLMs alone. The RAG platform 110, for example can be a component of the AI-driven cybersecurity threat detection and mitigation classifier system. The process flow 100, for example, can be performed by components of the AI-driven system, and can leverage knowledge data provided by the RAG platform 110.

The RAG platform 110 of the present example includes various telemetry components 120 (e.g., including an incident response component, managed detection and response (MDR) sensor components, scanners, managed awareness sessions, etc.), and various types of knowledge data 130 (e.g., incidents, cases, observations, assets, risks, security awareness insights, etc.). In general, the MDR sensor components can represent a computing component that remotely monitors, detects, and responds to security threats in an organization. In the present example, incidents can be derived from data from the incident response component, cases and observations can be derived from data from the MDR sensors, assets and risks can be derived from data from the scanners, and security awareness insights can be derived from data from the managed awareness sessions.

The RAG platform of the present example also includes an artificial intelligence (AI) component 160 that provides access to a knowledge base 162 that provides access to the knowledge data 130 (e.g., via an application programming interface (API)). For example, various customers 140 can submit natural language (NL) questions through a unified portal 152 of an interface 150, the unified portal 152 can retrieve data from the knowledge base 162 of the AI component 160, and the unified portal 152 can return NL answers that correspond to the NL questions to the customers 140.

Referring to the example process flow 100 of FIG. 1, a user 170 provides a user query 172. For example, the user query 172 can include information about a network security-related event (e.g., a possible malware attack, a phishing message, a security alert, or another sort of event), and that includes a request for an action to be performed in response to the event. In the present example, the user 170 can be a security analyst for an organization, and the user query 172 can be submitted by the analyst using a computing terminal that is communication with the AI-driven cybersecurity threat detection and mitigation classifier system.

Upon receiving the user query 172, for example, the AI-driven system can perform various actions for processing the query and returning a response. At a high level, query embedding is generated at 174. At 176, similar documents are retrieved from knowledge bases (e.g., the knowledge base 162 of the AI component 160 of the RAG platform 110). At 178, the query is augmented with the retrieved documents. At 180, a response is generated from a large language model (LLM). A retrieve/generate application programming interface (API) 182 can generate a response 184, based on user input (e.g., the user query 172) and on the response generated from the LLM (e.g., at 180).

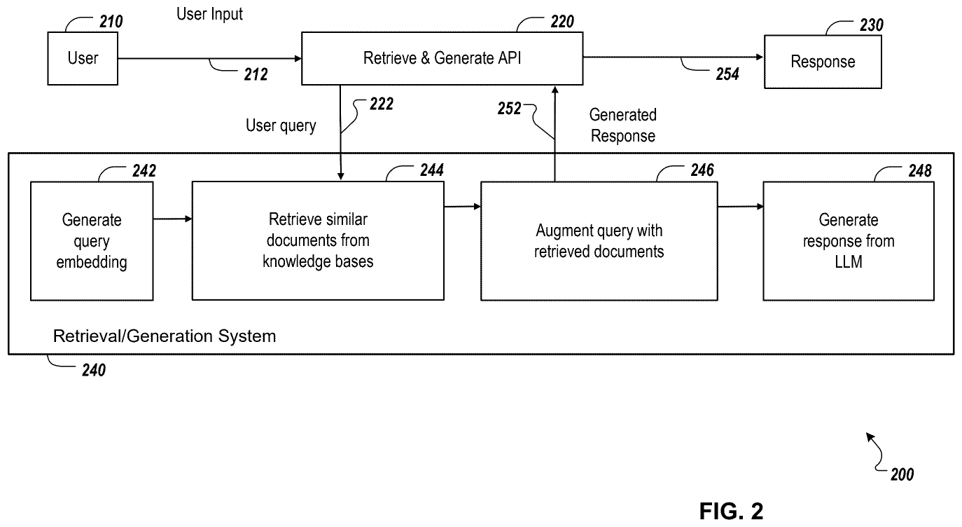

Referring to FIG. 2, an example process flow 200 for generating responses based on user input is shown. The process flow 200, for example, can be performed by the AI-driven cybersecurity threat detection and mitigation classifier system. In the present example, operations of the process flow 200 can be similar to operations of the process flow 100 (shown in FIG. 1), and are described with further detail here. As described further below, the process flow 200 implements a multi-phased Retrieval Augmented Generation (RAG) architecture specifically designed for cybersecurity applications.

At 212, a user 210 provides user input to a retrieve/generate application programming interface (API) 220. The user input (e.g., a question or prompt) from the user 210 (e.g., a security analyst, a customer, or another sort of user) can serve as a trigger for a retrieval process. At 222, the retrieve/generate API 220 provides the user query (e.g., based on the user input provided at 212) to a retrieval/generation system 240.

The retrieval/generation system 240, for example, can include various components for generating responses based on user queries. In the present example, the retrieval/generation system 240 can include a retriever, a generator, and a foundational AI model. In general, the foundational AI model (e.g., a large pre-trained language model) can be used for its ability to process language and context. Within the retrieval-generation system 240, for example, the foundational AI model can be used by the retriever to rank retrieved documents based on their relevance to the user query, and can be used by the generator to construct coherent and contextually relevant responses based on the combined input of the query and the retrieved documents.

In response to receiving the user query, for example, the retrieval/generation system 240 can use the retriever to generate a query embedding (at 242), and to retrieve similar documents from knowledge bases (at 244). Generating the query embedding, for example, can involve transforming a natural language query into a discrete parameterized query.

Retrieving the similar documents can involve searching through the knowledge bases (e.g., data sources, databases, etc.) to find the most relevant information. The searching can generally include the performance of algorithms that understand the query's intent and context to find suitable matches (e.g. through the use of the foundational AI model).

For example, the disclosed retrieval/generation system 240 may enable a semantic chunking and vector transformation query embedding. In that example, security telemetry and analyst feedback may undergo adaptive chunking based on historic data, such as an optimal set of actions to respond to a given event, as well as threat topology, rather than fixed-size segmentation. This domain-specific chunking creates semantically coherent threat pattern units that are transformed into a specialized vector space (i.e., embedding) where proximity correlates with attack technique similarity. This process may automate a large proportion of security analyst work by knowing and automating the questions and answer used to respond to a given evidence task (e.g., a security alert or other security event).

Continuing that example, the illustrative retrieval/generation system 240 may enable a dual-index knowledge store, which maintains two synchronized vector indices. The indices may include a primary “detection index” for identifying threats and a companion “mitigation index” that maps directly to countermeasures. This paired-index approach enables rapid retrieval of both detection context and appropriate response tactics.

As another example, the illustrative retrieval/generation system 240 may perform confidence-weighted retrieval. Unlike typical RAG systems, the illustrative system 240 employs a confidence-weighting algorithm that dynamically adjusts vector similarity thresholds based on (a) historical detection accuracy for similar threats, (b) data source reliability, and (c) threat criticality scores.

In some embodiments, the disclosed RAG platform 110 implements an advanced vector database architecture integrating Hierarchical Navigable Small World indexing and Product Quantization techniques to enable efficient similarity searches across billions of security event embeddings at sub-millisecond speeds. This approach is especially advantageous for extremely large data sets and helps organize security events in a multi-layered graph structure with logarithmic-time search complexity, while employing subspace quantization to compress high-dimensional vectors to 8-16 bytes per vector. This compression may reduce storage requirements by up to 97% while maintaining search precision critical for threat detection.

The illustrative system's hybrid sparse-dense embedding framework provides dual representation capabilities essential for effective cybersecurity analysis: for example, dense vectors (e.g., 768-1536 dimensions) capture semantic relationships between security events for identifying conceptually similar attack techniques and previously unseen variants, while sparse vectors (e.g., 10K-100K dimensions) preserve exact matches for critical attack indicators and known threat signatures. This architecture enables the GenAI system to dynamically balance between precision and recall based on security context, delivering both high-accuracy pattern matching for documented threats and semantic understanding for novel attack variations—capabilities that traditional keyword or signature-based systems cannot achieve.

After retrieving the documents from the knowledge bases, for example, the retrieval/generation system 240 can use the generator to augment the query with the retrieved documents (at 246), and to generate a response from a large language model (LLM) (at 248). Generating the response can include synthesizing the information from the query and the retrieved documents to generate a coherent response that aligns with the given context. The generator can use the capabilities of the LLM to produce natural language text that serves as the response, or as a continuation of an input prompt. In the illustrative embodiment, the generator may augment traditional language model output with temporal context, for example incorporating a sliding window of network state transition data to recognize evolving attack patterns. This allows the system to update threat classifications in real-time as attacks progress through kill chain stages.

After generating the response, the response can be delivered to a user (e.g., the user 210 that provided the user input 212. At 252, the retrieval/generation system 240 returns the generated response to the retrieve/generate API 220. At 254, the retrieve/generate API 220 provides the generated response (here shown as response 230).

As discussed above, the illustrative system may periodically reorganize its vector space based on analyst feedback, automatically identifying and segregating threat clusters that frequently generate false positives for targeted retraining or refinement, which effectively creates “correction zones” in the vector space. This architecture's novelty stems from its security-specific adaptations to traditional RAG, creating a self-evolving threat intelligence system that continuously refines its understanding of the relationship between network behaviors, attack techniques, and effective mitigations through a specialized vector space optimized for cybersecurity applications.

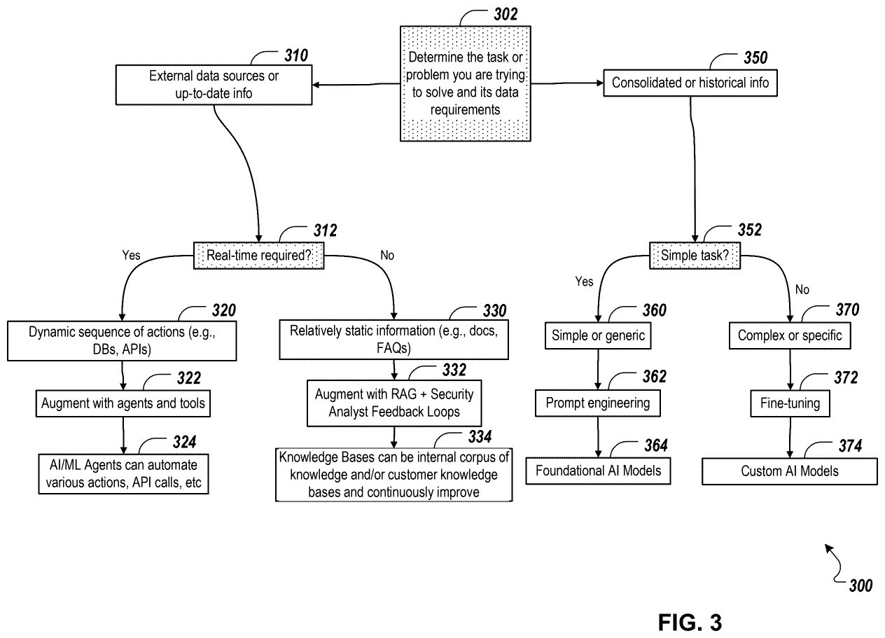

Referring to FIG. 3, an example decision tree 300 is shown for classifying tasks, based on data features of the tasks. In general, the decision tree 300 can be employed by an automated process for performing the classification at ingestion. As telemetry data corresponding to various security events, alerts, and detections are received, automation rules can be employed to classify and automate responses. Based on the logic of the classification, for example, various actions can take place autonomously while the data is ingested. In the present example, autonomous agents can interact directly with application programming interfaces (APIs). Implementing the agent functionality directly in a serverless routine such as a Lambda function can include using the input context to derive parameters and make API calls without the need for intermediary steps. For example, such agents can use machine learning models to interpret the input context and to automatically set API parameters. The machine learning models can be trained on existing manual security playbooks that describe the actions a security analyst should take when a particular detection/alert occurs. Accordingly, the disclosed decision tree 300 may enable real-time, intelligent decision-making with serverless environments, which may reduce complexity and latency. Thus, the disclosed decision tree 300 may streamline automation, allowing systems to respond dynamically to inputs without manual intervention or hard-coded logic.

At 302, a determination is performed of a cybersecurity case or evidence task that is to be handled (e.g., a problem that is to be solved), and its data features. An evidence task may include a log, an alert, or other indicator of compromise. The evidence task may be automatically determined by an AI model based on historic data, Reinforcement Learning from Human Feedback (RLHF), and/or Reinforcement Learning from AI Feedback (RLAIF).

At 310, the data features (e.g., data requirements) of the task can involve external data sources and/or up-to-date information. The data features of the task may be determined by understanding historic data cause and effect as codified into the AI model, which knows the optimal set of actions to take based on a security log, event or alert.

At 312, a determination is performed as to whether real-time processing is needed for handling the task. For example, the particular data features for the task may be evaluated. Real-time processing may be needed for data features including a dynamic sequence of actions such as database or API accesses. Real-time processing may not be needed for relatively static information, such as documents, FAQs, or relatively static information.

At 320, if real-time processing is needed for handling the task, a dynamic sequence of actions for handling the task is determined (e.g., based on databases, application programming interfaces (APIs), etc.). At 322, an augmentation process is performed with agents and tools. The augmentation process may include the enrichment of the evidence, ticket, or response using generative AI in combination with tools and orchestration that is guided by historic cause/effect data. At 324, artificial intelligence and/or machine learning agents can automate various actions, API calls, and so forth.

For example, in an embodiment, the augmentation process may leverage a specialized threat-context agent that dynamically synthesizes retrieved patterns with real-time network topology data, creating enriched threat scenarios that incorporate potential lateral movement paths and asset vulnerability context. This process may be facilitated by three integrated tools: a Query Formulation Engine that translates detection signals into investigation pathways, an Impact Assessment Module that calculates organization-specific risk vectors, and a Mitigation Selection System that matches threats to appropriate countermeasures from the mitigation index based on network configuration constraints and resource availability.

As an illustrative example, in a cyber security operations center (SOC), a Retrieval-Augmented Generation (RAG) system may process an analyst's query such as, “Has this IP been seen in past incidents?” by retrieving relevant threat intelligence and historical ticket data from a vector database, then generating a contextualized, natural language summary to support faster decision-making and incident response.

At 330, if real-time processing is not needed for handling the task, relatively static information is determined (e.g., based on documents, frequently asked questions (FAQs), etc.) At 332, an augmentation process is performed with retrieval augmented generation (RAG), and security analyst feedback loops. At 334, knowledge bases (e.g., an internal corpus of knowledge) and/or customer knowledge bases can be continually improved. To maintain a continuously updated RAG knowledge base for a cybersecurity LLM, customer logs, internal SOC telemetry, and external threat intelligence sources (e.g., MISP, VirusTotal, OpenCTI, or other source) are ingested via an ETL pipeline that normalizes the data into a consistent schema such as OCSF or ECS. As described above, the pipeline preprocesses this data by chunking semantically meaningful sections (e.g., incident summaries, IOCs, detection rules), generating embeddings using an LLM-compatible model such as Amazon Titan Embeddings or OpenAI ADA, and storing the embeddings in a vector database such as pgvector or Pinecone. Metadata is attached to each embedding for traceability and grounding. An event-driven architecture using tools like AWS Lambda and Step Functions may provide real-time or scheduled updates as new security data arrives, while the system periodically refreshes older vectors to account for model drift and changes in organizational threat posture. This ensures that the LLM can perform low-latency, context-rich retrieval to generate accurate, up-to-date responses for analysts.

At 350, the data features of the task can involve consolidated and/or historical information. At 352, a determination is performed as to whether the task is a simple task that can be performed with high confidence with a LLM as opposed to a complex task that requires human agency and a human in the loop.

The decision engine incorporates a novel explainable AI framework that provides security analysts with transparent reasoning chains for all recommendations. Using attribution techniques based on integrated gradients and counterfactual analysis, the system generates natural language explanations that detail: (1) which specific log patterns triggered the classification, (2) what historical cases informed the recommendation, and (3) what alternative paths were considered and why they were rejected. This explainability layer establishes trust with security operators and facilitates compliance with regulations requiring human-understandable security decisions.

In an illustrative embodiment, the system implements a specialized temporal reasoning framework using a modified Transformer-XL architecture that maintains an extended context window of tokens, allowing it to identify relationships between security events separated by significant time intervals, which is a common characteristic of advanced persistent threats (APTs). This architectural enhancement enables the detection of low-and-slow attack patterns that typically evade traditional security analytics. The temporal reasoning module incorporates explicit time-decay attention mechanisms that weight the relevance of historical events based on their recency, attack stage, and statistical correlation with known compromise indicators.

At 360, if the task is a simple task, simple or generic information is determined. At 362, a prompt engineering process is performed. Prompt engineering may include the process of designing and refining the inputs (prompts) that are given to an AI model—especially an LLM—to guide the model toward producing accurate, relevant, and useful responses. At 364, foundational AI models are leveraged.

At 370, if the task is not a simple task, complex or specific information is determined. At 372, a fine-tuning process is performed. Fine-tuning may include training an LLM on domain-specific data to improve its understanding, reasoning, and generation within that context. Such domain-specific data in the cybersecurity context may include security alerts, analyst notes, and incident reports. While RAG handles real-time retrieval of fresh knowledge, fine-tuning enhances the model's baseline capabilities, such as recognizing cybersecurity terminology or producing more structured, accurate responses, which may reduce the need for overly complex prompts. Together, fine-tuning and prompt engineering work in tandem: one improves the model itself, and the other optimizes how the model is used. At 374, custom AI models are leveraged.

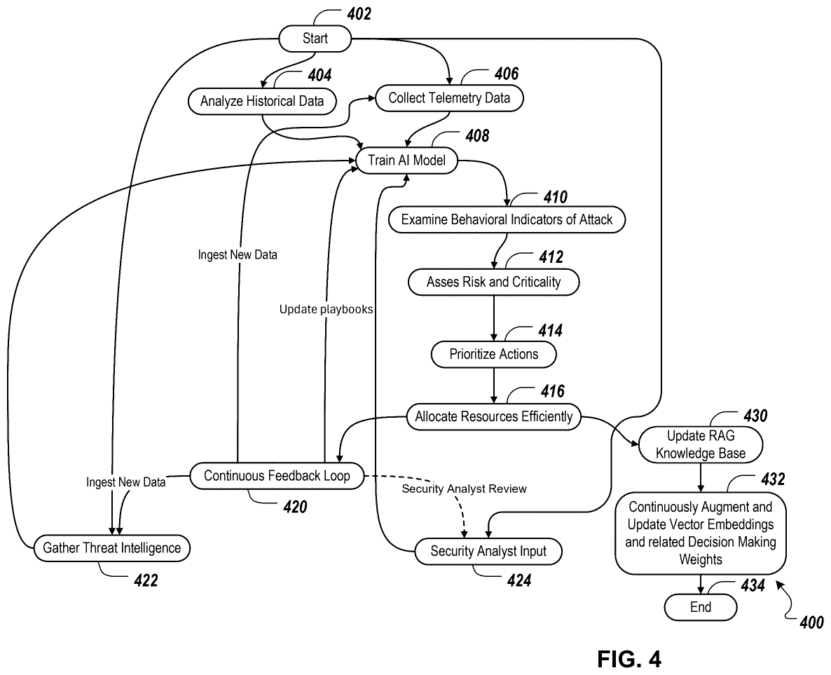

Referring to FIG. 4, an example process flow 400 for training and refining an artificial intelligence (AI) model is shown, including a continuous feedback loop. In general, the AI model can undergo continuous refinement with a comprehensive dataset of known cyber threats and vulnerabilities, threat intelligence, and a corpus of cyber events, alerts, and detections using supervised learning techniques that continuously improve through classifications, rules, and logic of value. The AI model can continuously monitor network traffic, system logs, and other relevant data sources in real-time, interacting with its environment. Further, input provided by security analysts (e.g., through a feedback mechanism, a voting mechanism, etc.) can provide reinforcement learning of the model's performance. By continuously incorporating feedback (e.g., feedback provided by security analysts, customers, etc.) and performing fine tuning processes, for example, a knowledge base can be configured for improved explainability. Further, human augmented intelligence can be used to improve security telemetry and data.

The present approach for training and refining the AI model (e.g., including the continuous feedback loop) examines indicator of attack (IoA) behaviors, and prioritizes based on insights gained from human feedback and historical data. This enables the AI model to dynamically filter classifications to prioritize mitigations based on risk and/or value derived by the action around various metrics (e.g. criticality, risk levels, etc.). In the present example, continuous feedback from security analysts, ingested telemetry data, and ingested playbooks, threat intelligence and behavioral indicators can improve time to value and signal to noise ratio, and can improve allocation of resources.

At 402, the example process flow 400 starts.

At 404, historical data is analyzed. For example, data that pertains to previous queries and actions for various different alert, event, and/or case types can be analyzed.

At 406, telemetry data is collected. For example, telemetry data that pertains to the occurrence of previous security events, alerts, and detections, can be collected.

At 408, an artificial intelligence (AI) model is refined, trained, or otherwise adapted using the historical data analyzed at 404 and/or the telemetry data collected at 406. For example, the AI model can continuously monitor network traffic, system logs, and other relevant data sources in real-time. Further, the AI model in the present example can undergo continual and incremental improvement through the use of reinforcement learning with human feedback. For example, the AI model can learn how security analysts spend their time, what searches and queries they conduct, what actions they perform, and so forth. Leveraging a retrieval augmented generation (RAG) approach, for example, semantic representations of the human feedback can be embedded as vectors or as numerical representations of a semantic relationship to modify model weights. Based the human feedback (e.g., time spent, conducted searches and queries, etc.), opportunities can be identified for fine-tuning an AI classification, and for adding automation. For example, automation opportunities may include automation for handling failed logins, automation for handling configuration changes, automation for configuring load level/throttling in response to brute force attacks, automation for implementing account self-service and user lockout, and other automated processes.

Optimizing an LLM for a specific task or domain such as cybersecurity may employ a layered approach involving several “training,” refinement, and adaptation techniques. Each of those techniques has a different level of complexity, customization, and compute cost. For example, training an LLM is typically an expensive operation, and thus the disclosed system may employ a pre-trained foundation model or other pretrained LLM, in combination with other less compute-intensive techniques for refining or otherwise improving performance of the LLM. Various techniques for refining LLMs as described above include prompt engineering, few-shot learning, instruction tuning, fine-tuning, and RAG-based optimization.

In an illustrative embodiment, the disclosed system may implement a zero-shot learning capability through a contrastive learning approach that enables generalization to previously unseen attack vectors. By training on a diverse corpus of cybersecurity incidents and their corresponding classifications (e.g., MITRE ATT&CK classifications), the model learns to project security events into a universal threat space where similar attack techniques cluster together regardless of their specific implementation details. This enables the identification of novel attack variations without requiring explicit examples during training. The zero-shot framework may be continuously updated through a federated learning architecture that aggregates knowledge from deployed instances while preserving customer data privacy through differential privacy techniques and secure multi-party computation. In some embodiments, the AI model may be periodically evaluated using adversarial testing procedures to identify and address potential blind spots in threat detection capabilities as well as potential drift in the classification models.

At 410, behavioral indicators of attack are examined (e.g., based on the telemetry data collected at 406). In general, through the use of artificial intelligence (AI), alert data and contextual information can be analyzed. In the present example, contextual information can refer to an improvement of understanding of a security threat, and the risk that it poses, to facilitate resource allocation and prioritization in response. Such contextualization is generally not signature-based, but instead can be based on an examination of behavioral indicators of attack that are associated with an actual security threat.

At 412, risk and criticality are assessed. In general, common weakness enumeration (CWE) techniques can be used to assess risk and criticality. In the present example, CWE can refer to a category system for identifying system weaknesses and vulnerabilities. Through use of the CWE techniques, for example, risk and criticality can be assessed based on a probability that a computer-based asset could be exploited, in addition to an impact of the exploit. For example, a function of Threat×Vulnerability\Defense=Risk Score (e.g., a risk value) can inform the assessment of risk and criticality.

At 414, actions are prioritized. In general, the most critical alerts can be prioritized based on various factors (e.g., threat level, potential impact, detection confidence, etc.). A potential impact, for example, can include an impact on revenue, reputation, etc. A detection confidence, for example, can refer to a likelihood that a security alert is not a false positive or false negative. These techniques can help reduce alert fatigue by filtering out false positives and low-risk alerts, thereby allowing security analysts to appropriately focus their time.

At 416, resources are efficiently allocated. For example, mean time to detect and respond (MTTD/R) can be improved by allowing security analysts to quickly triage and respond to the highest-priority security threats.

At 420, a continuous feedback loop is performed. In general, the AI model can be continuously trained with dynamic labels. For example, the AI model can learn from past curated queries and from past curated actions related to cybersecurity alerts and events to identify patterns and trends associated with different security threats. In the present example, new data can be ingested (e.g., at 406, where telemetry data is collected), and playbooks can be updated (e.g., at 410, where the AI model is trained). The playbooks, for example, can be updated with natural language prompts, and can involve the use of a large language model (LLM). For example, a prompt can include instructions for the LLM, such as “develop playbook and automation scripts for the detection of X, Y, and Z, which were responsible for resources spent on detection and response.” Further, at 422, the ingesting of new data can involve the gathering of threat intelligence, which can be provided for the training of the AI model (e.g., at 408).

In some implementations, the continuous feedback loop can include human feedback integration. In general, the AI model can send predictions to human analysts, and the human analysts can provide validation and feedback based on their domain knowledge, which can be incorporated into the AI model to improve accuracy. Further, actions that are performed by the human analysts can also be incorporated into the AI model. For example, at 424, security analyst input can be received (e.g., as the result of a security analyst review being performed), and can also be provided to train the AI model (e.g., at 408). The predictions can be associated with indicators of attack (IoA), and can also be informed by a knowledge base of adversary tactics and techniques (e.g., MITRE ATT&CK, or another sort of knowledge base) to determine a probability that a threat will be able to exploit a network and/or device vulnerability. Additionally, the AI model can learn from past curated queries that are linked to past cybersecurity alerts and events (e.g., questions that were previously prompted to and/or asked by analysts and/or customers, and that have been tokenized) and past curated actions (e.g., tokenized actions) that were performed in response to the cybersecurity alerts and events, to identify patterns and trends associated with different security threats. Such patterns and trends, for example, can help determine optimal mitigation action, whether humans are to be in the loop, whether a customer can perform self-service and/or whether a simple configuration change may exist, and so forth.

At 430, when resources have been efficiently allocated, for example, a retrieval augmented (RAG) knowledge base can be updated. For example, the feedback response may be maintained as vectorized embeddings in a retrieval augmented generation (RAG) knowledge base that is periodically updated with emerging threat intelligence and analyst insights through an adaptive semantic chunking process based on threat topology rather than fixed-size segmentation. The system implements an innovative multi-phased Retrieval Augmented Generation (RAG) architecture for cybersecurity that employs adaptive semantic chunking based on threat topology and historical response data, automating significant portions of tier 1 and 2 security work through curated query prediction. The system maintains synchronized dual vector indices—detection and mitigation—that enable rapid identification of threats and appropriate countermeasures while employing confidence-weighted retrieval that dynamically adjusts similarity thresholds based on historical accuracy, source reliability, and threat criticality. The temporal-contextual generation component incorporates network state transitions to recognize evolving attack patterns in real-time, while the RLHF/RLAIF feedback-driven index restructuring periodically reorganizes the vector space to isolate false positive clusters for targeted retraining. This security-specific adaptation of RAG creates a self-evolving threat intelligence system that continuously refines its understanding of network behaviors, attack techniques, and effective mitigations.

At 432, vector embeddings and related decision making weights can be continuously augmented and updated. For example, as described above, the system may use vector embeddings that utilize a novel multi-dimensional representation scheme where threat characteristics, network behaviors, and mitigation effectiveness are encoded in separate but interconnected subspaces. This creates a composite embedding that preserves critical relationships between detection signals and response efficacy. Accordingly, the disclosed AI system may effectively codify rules that govern the distribution of historic data. In an embodiment, decision-making weights may be dynamically calibrated through a continuous Bayesian optimization process that incorporates time-decay functions for aging intelligence, confidence multipliers derived from detection accuracy history, and context-sensitive amplification factors based on asset criticality within the network topology. These weighted embeddings feed downstream processes including the alert prioritization engine, the automated mitigation selector, and the explainability module. The alert prioritization engine ranks threats based on vector proximity to known high-impact incidents. The automated mitigation selector identifies countermeasures with optimal effectiveness-to-disruption ratios. The explainability module translates embedding relationships into human-interpretable threat narratives for security analyst review.

At 434, the example process flow 400 ends.

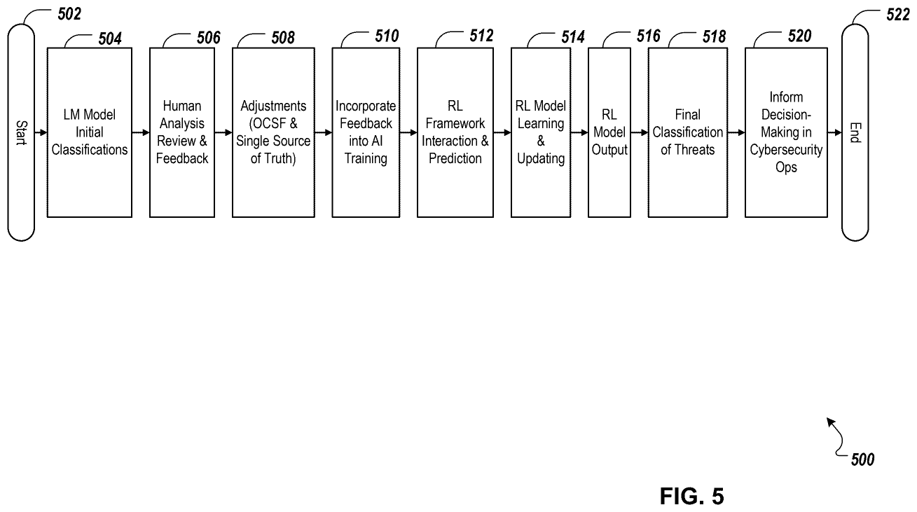

Referring to FIG. 5, an example process flow 500 is shown for using human augmented reinforcement learning to fine tune model detection classifications. For example, a security alert can be initially classified by the AI-driven cybersecurity and mitigation classifier system, and human augmented reinforcement learning can be used to fine tune the initial classification. In general, subsequent actions and/or automations can be performed based at least in part on how the security alert has been classified. Thus, an AI classifier can learn over time, for example, by predicting questions that are likely to be submitted by a security analyst based on the security alert, providing the predicted questions to the analyst as a set of recommendations, monitoring a selection of one or more of the questions, incrementally training the AI classifier based on the selection, and providing a new prediction of follow-up questions based on the selection.

At 502, the example process flow 500 starts.

At 504, initial classifications are determined for a language model (LM).

At 506, review and feedback are collected from human analysts. For example, an AI model's initial indicator of attack (IoA) classification can be vetted by a security analyst for feedback and correction using according to various cybersecurity standards.

At 508, automated data enrichment and schema normalization is performed on the review and feedback. For example, the adjustments can be performed according to an Open Cybersecurity Schema Framework (OCSF), a Single Source of Truth (SSOT), or another sort of framework and/or source of data. In general, OCSF can provide a standard schema for common security events, can define versioning criteria to facilitate schema evolution, and can include a self-governance process for security log producers and consumers. In general, SSOT can involve a practice of performing data aggregation from many systems within an organization to a single location.

In some embodiments, the AI model may utilize a multi-modal architecture that processes both structured network telemetry data (e.g., OCSF-normalized data) and unstructured threat intelligence reports to enhance detection accuracy. Classification enrichment and normalization and vectorization may enable the ability to detect semantic/cosine similarities of vectors, solving for the challenge of not having a homogeneous threat/vulnerability data set and from ingesting prodigious data sets from different telemetry using different schema.

At 510, feedback is incorporated into artificial intelligence (AI) training. For example, the feedback can be used to enhance the AI-driven system's learning, and to improve classification accuracy.

At 512, reinforcement learning (RL) framework interaction and prediction is determined. For example, the RL framework can predict security threats by analyzing both the initial classifications and the review and feedback from the human analysts. The review and feedback from human analysts, for example, can be maintained as vectorized embeddings (e.g., numerical representations) in a retrieval augmented generation (RAG) knowledge base.

At 514, RL model learning and updating is performed. For example, an AI model can continuously update its learning and decision making based on security analyst feedback and prediction results.

At 516, RL model output is generated.

At 518, a final classification of threats is performed. The final classification, for example, can combine the RL model output with the AI model's initial data, to classify cybersecurity risks. The classifications can continuously improve as data, telemetry, and threat intelligence is ingested and as the AI model continuously improves.

At 520, decision making processes (e.g., in cybersecurity operations) are informed. For example, a security analyst, cybersecurity customer, or other user may evaluate and/or implement recommendations from the AI model classification.

At 522, the example process flow 500 ends.

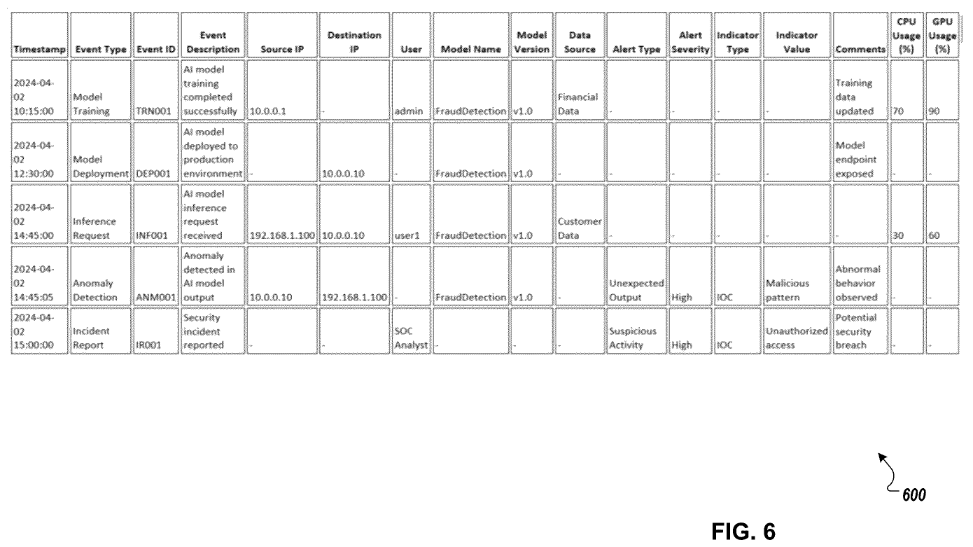

Referring to FIG. 6, an example schema 600 of an open cybersecurity schema framework (OCSF) to improve data standardization and classification context of an AI model is shown. If different security threat feeds are received in different formats, for example, the AI-driven cybersecurity threat detection and mitigation classifier system can parse and output the data in the common schema. Through use of the common schema, for example, the performance of model embeddings can be improved as common semantic relationships are being compared. Further, the common schema can help reduce hallucinations by the AI model. In the present example, the schema 600 can include a timestamp, an event type (e.g., model training, model deployment, inference request, anomaly detection, incident report, etc.), an event identifier, an event description, a source address, a user, a model name, a model version, a data source, an alert type, an alert severity, an indicator type, an indicator value, comments, a CPU usage percentage, and a GPU usage percentage. Other examples can include fewer elements, additional elements, and/or different elements.

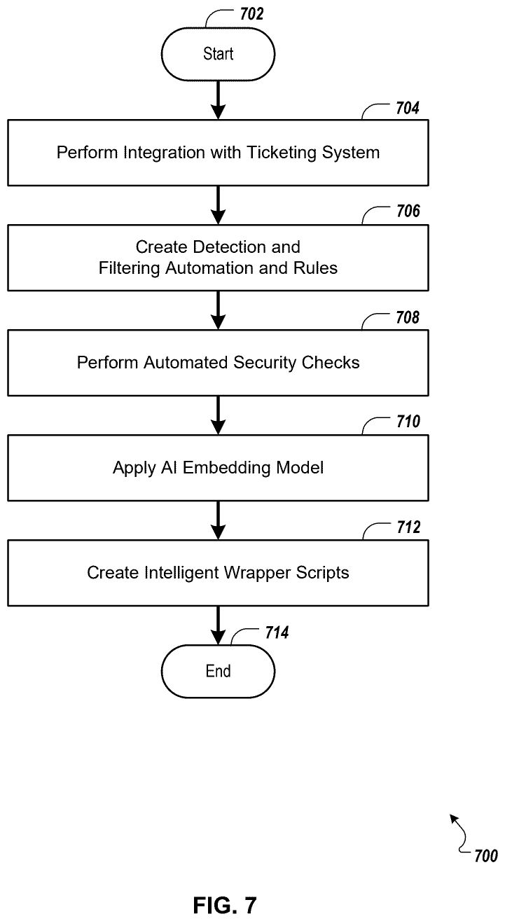

Referring to FIG. 7, an example process flow for incorporating automation and a unified schema for classifying detections is shown. In general, once data has been standardized (e.g., according to the example schema 600, shown in FIG. 6), an integration can be performed between an analyst workflow and the AI-driven cybersecurity threat detection and mitigation classifier system. To accomplish the integration, for example, automation techniques can be used and a unified schema for classifying detections can be leveraged.

In the present example, integration with a ticketing system can be performed. In general, ticketing systems can be used to help security analysts organize, describe, and archive event investigations and incidents. If an incoming security alert is classified as an indicator of attack (IoA), for example, the ticketing system can communicate that information by issuing a ticket (e.g., through an automatic action, through a human prompted action, etc.). Likewise, if a system user (e.g., a cybersecurity customer) has a question regarding operations of the AI-driven cybersecurity threat detection and mitigation classifier system (or cybersecurity in general), the system user can communicate the question via the ticketing system. The AI-driven system of the present example can learn and apply an optimal decision from the ticketing system communications that occur.

At 702, the example process flow 700 starts.

At 704, integration with a ticketing system is performed. For example, when a security analyst creates a new detection playbook, the analyst can log it as a ticketing system issue. The ticketing system may or may not serve as a single source of truth in a retrieval augmented generation (RAG) platform's knowledge base. However, in some implementations the ticketing system can serve as a centralized repository for detection playbooks, thus ensuring consistency and traceability. For example, the ticketing system may maintain a centralized repository of detection playbooks that are used to train or further refine the AI model, and are version-controlled to maintain an audit trail of detection strategy evolution.

At 706, detection and filtering automation and rules are created. For example, the detection and filtering automation and rules can be created as outputs of playbooks and ticketing system actions. In the present example, an AI model of the AI-driven system can ingest and continuously improve rules and filters, learning from tickets generated by the ticketing system (and the performance of associated actions) as part of detection filters and response playbooks. As described above, existing runbooks, playbooks, and other data may be transformed to vectorized embeddings, which may steer the AI LLM in a more deterministic and effective way. Relevant issue types can include predefined fields such as in-scope products, services, infrastructure, attack types, and security information and event management (SIEM) search logic. A standardized rule can ensure that detections contain essential information and adhere to a consistent format.

At 708, automated security checks are performed. Upon submission of a new detection, for example, an automated process can be triggered to validate a playbook against a unified schema for classifying detections. The unified schema can define the attributes and formatting standards for each detection. The automated process can check whether the submitted detection meets specified standards and can provide feedback to a security analyst if discrepancies are found.

At 710, an artificial intelligence (AI) embedding model is applied (e.g., integration with the RAG platform's knowledge base). For example, vectorized embeddings can be applied using an AI embedding model to help automate a workflow further. The embeddings, for example, can encode textual information from the detection playbook into numerical vectors, allowing for automated analysis and comparison of detection attributes. Thus, detection validation and propagation throughout an alerting pipeline can be performed more efficiently.

At 712, intelligent wrapper scripts are created. The intelligent wrapper scripts may include code that dynamically adapts to the required schema. For example, the unified schema can facilitate the creation of intelligent wrapper scripts for detection playbooks. The scripts can leverage the standardized format of the detections to automate the propagation of intelligence across various systems and components within the organization's alerting pipeline. Thus, relevant threat intelligence can be efficiently disseminated to all relevant stakeholders and systems.

At 714, the example process flow 700 ends.

By integrating automation and a unified schema into a security analyst workflow, for example, the consistency and quality of detection playbooks can be improved while streamlining the process of detection creation and validation. Further, leveraging AI techniques such as vectorized embeddings can enhance workflow efficiency, enabling faster and more accurate analysis of detection attributes. Overall, this integrated approach can enhance an organization's cybersecurity posture by facilitating the rapid identification and mitigation of security threats.

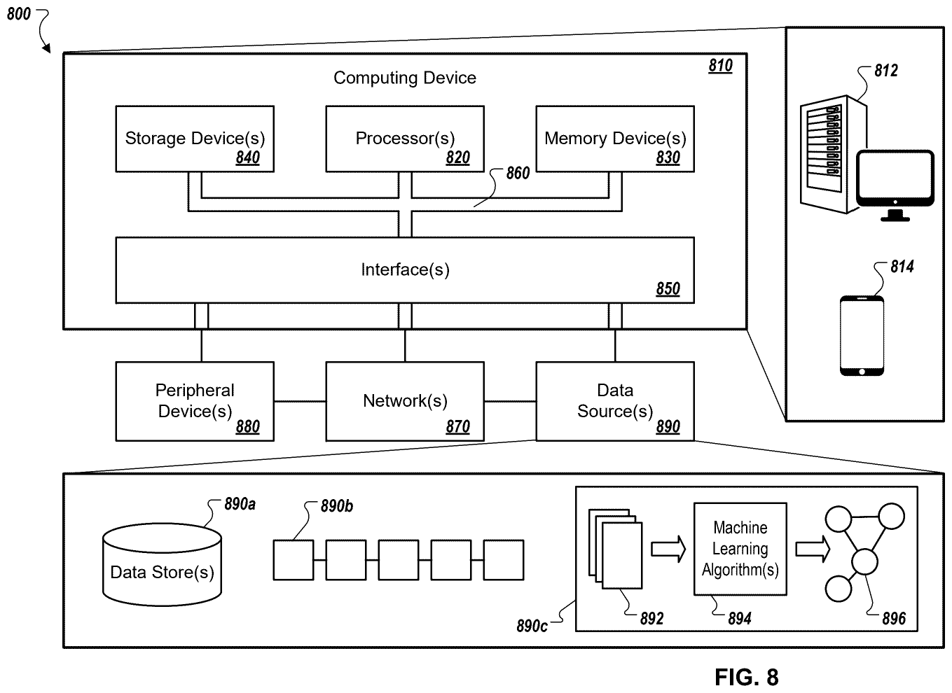

FIG. 8 is a schematic diagram that shows an example of a computing system 800 that can be used to implement the techniques described herein. The computing system 800 includes one or more computing devices (e.g., computing device 810), which can be in wired and/or wireless communication with various peripheral device(s) 880, data source(s) 890, and/or other computing devices (e.g., over network(s) 870). The computing device 810 can represent various forms of stationary computers 812 (e.g., workstations, kiosks, servers, mainframes, edge computing devices, quantum computers, etc.) and mobile computers 814 (e.g., laptops, tablets, mobile phones, personal digital assistants, wearable devices, etc.). In some implementations, the computing device 810 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 810, and an entire system can be made up of multiple devices communicating with each other. For example, the computing device 810 can be part of a computing system that includes a network of computing devices, such as a cloud-based computing system, a computing system in an internal network, or a computing system in another sort of shared network. Processors of the computing device (810) and other computing devices of a computing system can be optimized for different types of operations, secure computing tasks, etc. The components shown herein, and their functions, are meant to be examples, and are not meant to limit implementations of the technology described and/or claimed in this document.

The computing device 810 includes processor(s) 820, memory device(s) 830, storage device(s) 840, and interface(s) 850. Each of the processor(s) 820, the memory device(s) 830, the storage device(s) 840, and the interface(s) 850 are interconnected using a system bus 860. The processor(s) 820 are capable of processing instructions for execution within the computing device 810, and can include one or more single-threaded and/or multi-threaded processors. The processor(s) 820 are capable of processing instructions stored in the memory device(s) 830 and/or on the storage device(s) 840. The memory device(s) 830 can store data within the computing device 810, and can include one or more computer-readable media, volatile memory units, and/or non-volatile memory units. The storage device(s) 840 can provide mass storage for the computing device 810, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 850 can include various communications interfaces (e.g., USB, Near-Field Communication (NFC), Bluetooth, WiFi, Ethernet, wireless Ethernet, etc.) that can be coupled to the network(s) 870, peripheral device(s) 880, and/or data source(s) 890 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 850 can include a control interface that receives commands from an input device (e.g., operated by a user) and converts the commands for submission to the processors 820. The interface(s) 850 can include a display interface that includes circuitry for driving a display to present visual information to a user. The interface(s) 850 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 870 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 810 can communicate with the peripheral device(s) 880, the data source(s) 890, and/or other computing devices over the network(s) 870. In some implementations, the computing device 810 can directly communicate with the peripheral device(s) 880, the data source(s), and/or other computing devices.

The peripheral device(s) 880 can provide input/output operations for the computing device 810. Input devices (e.g., keyboards, pointing devices, touchscreens, microphones, cameras, scanners, sensors, etc.) can provide input to the computing device 810 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 810 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 890 can provide data for use by the computing device 810, and/or can maintain data that has been generated by the computing device 810 and/or other devices (e.g., data collected from sensor devices, data aggregated from various different data repositories, etc.). In some implementations, one or more data sources can be hosted by the computing device 810 (e.g., using the storage device(s) 840). In some implementations, one or more data sources can be hosted by a different computing device. Data can be provided by the data source(s) 890 in response to a request for data from the computing device 810 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 890a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 890b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 890c. The machine learning system(s) 890c, for example, can be used to analyze data from various sources (e.g., data provided by the computing device 810, data from the data store(s) 890a, data from the blockchain(s) 890b, and/or data from other data sources), to identify patterns in the data, and to draw inferences from the data patterns. In general, training data 892 can be provided to one or more machine learning algorithms 894, and the machine learning algorithm(s) can generate a machine learning model 896. Execution of the machine learning algorithm(s) can be performed by the computing device 810, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A cybersecurity threat detection and mitigation system, comprising:
at least one processor; and
memory storing instructions that, when executed by the at least one processor, cause the system to perform operations comprising:
refining an artificial intelligence (AI) model with a corpus of historical security data that represents security events that occurred across a computer network, queries that were submitted by security analysts in response to the security events, and actions that were performed for mitigating the security events;
collecting real-time telemetry data that corresponds to behavior and performance of the computer network;
providing the real-time telemetry data to the AI model;
analyzing, by the AI model, the real-time telemetry data in conjunction with the historical security data to identify a potential security threat to the computer network using multi-dimensional vector representations that encode threat characteristics, network behaviors, and mitigation effectiveness in interconnected subspaces;
performing, by the AI model, an assessment of risk to the computer network for the potential security threat; and
when the assessment of risk to the computer network indicates that the potential security threat is an actual security threat, triggering a security alert that corresponds to the actual security threat.

2. The system of claim 1, wherein performing the assessment of risk to the computer network comprises:
dynamically adjusting a threshold value based on network conditions and threat intelligence feeds through a continuous Bayesian optimization process incorporating time-decay functions for aging intelligence;
determining a risk value that corresponds to the potential security threat; and
comparing the risk value to the threshold value, wherein the potential security threat is indicated as an actual security threat when the determined risk value meets the threshold value.

3. The system of claim 1, the operations further comprising:
when the assessment of risk to the computer network indicates that the potential security threat is an actual security threat, determining, by the AI model, at least one automated mitigation action based on a type of the actual security threat; and
initiating the at least one automated mitigation action.

4. The system of claim 1, the operations further comprising:
predicting, by the AI model, at least one query for investigating the actual security threat by translating detection signals into investigation pathways; and
providing the predicted at least one query for presentation to a security analyst through a user interface with supporting evidence and confidence scores for each predicted query.

5. The system of claim 4, the operations further comprising:
receiving, through the user interface, a selection of the at least one query;
executing the at least one query, and returning a result based on the executing for presentation through the user interface;
providing, to the AI model, query selection data that indicates that the at least one question was selected;
receiving, through the user interface, a feedback response from the security analyst indicative of effectiveness of mitigation actions taken in response to the query results; and
incrementally refining the AI model based on the query selection data and the effectiveness of mitigation actions taken in response to the query results through Reinforcement Learning from Human Feedback (RLHF).

6. The system of claim 5, the operations further comprising incrementally refining the AI model with a dual feedback loop combining the Reinforcement Learning from Human Feedback (RLHF) with Reinforcement Learning from AI Feedback (RLAIF).

7. The system of claim 1, wherein refining the AI model comprises automatically restructuring a vector index for the multi-dimensional vector representations.

8. The system of claim 1, the operations further comprising:
prioritizing the security alert, based on (i) a potential impact of the potential security threat on an organization that operates the security network, (ii) a detection confidence that corresponds to a likelihood that the security alert is not a false positive or a false negative, and (iii) the potential lateral movement paths available to the threat actor based on network topology analysis.

9. The system of claim 1, wherein collecting the real-time telemetry data comprises:
receiving the real-time telemetry data through multiple different security threat feeds, each security threat feed having a different data format; and
outputting the real-time data in a common schema with standardized metadata tagging for cross-correlation across different data sources.

10. The system of claim 1, the operations further comprising:
in response to the security alert being an indicator of attack, issuing a ticket that corresponds to the actual security threat, by a ticketing system that is integrated with the cybersecurity threat detection and mitigation system; and
automatically assigning the ticket to an appropriate security team based on a threat classification and team expertise.

11. A method for cybersecurity threat detection and mitigation, the method comprising:
refining, by a computing device, an artificial intelligence (AI) model with a corpus of historical security data that represents security events that occurred across a computer network, queries that were submitted by security analysts in response to the security events, and actions that were performed for mitigating the security events;
collecting, by the computing device, real-time telemetry data that corresponds to behavior and performance of the computer network;
providing, by the computing device, the real-time telemetry data to the AI model;
analyzing, by the AI model, the real-time telemetry data in conjunction with the historical security data to identify a potential security threat to the computer network using multi-dimensional vector representations that encode threat characteristics, network behaviors, and mitigation effectiveness in interconnected subspaces;
performing, by the AI model, an assessment of risk to the computer network for the potential security threat; and
when the assessment of risk to the computer network indicates that the potential security threat is an actual security threat, triggering, by the computing device, a security alert that corresponds to the actual security threat.

12. The method of claim 11, wherein performing the assessment of risk to the computer network comprises:
dynamically adjusting a threshold value based on network conditions and threat intelligence feeds through a continuous Bayesian optimization process incorporating time-decay functions for aging intelligence;
determining a risk value that corresponds to the potential security threat; and
comparing the risk value to the threshold value, wherein the potential security threat is indicated as an actual security threat when the determined risk value meets the threshold value.

13. The method of claim 1, further comprising:
when the assessment of risk to the computer network indicates that the potential security threat is an actual security threat, determining, by the AI model, at least one automated mitigation action based on a type of the actual security threat; and
initiating, by the computing device, the at least one automated mitigation action.

14. The method of claim 11, further comprising:
predicting, by the AI model, at least one query for investigating the actual security threat by translating detection signals into investigation pathways; and
providing, by the computing device, the predicted at least one query for presentation to a security analyst through a user interface with supporting evidence and confidence scores for each predicted query.

15. The method of claim 14, further comprising:
receiving, by the computing device through the user interface, a selection of the at least one query;
executing, by the computing device, the at least one query, and returning a result based on the executing for presentation through the user interface;
providing, by the computing device to the AI model, query selection data that indicates that the at least one question was selected;
receiving, by the computing device through the user interface, a feedback response from the security analyst indicative of effectiveness of mitigation actions taken in response to the query results; and
incrementally refining, by the computing device, the AI model based on the query selection data and the effectiveness of mitigation actions taken in response to the query results through Reinforcement Learning from Human Feedback (RLHF).

16. The method of claim 15, further comprising incrementally refining, by the computing device, the AI model with a dual feedback loop combining the Reinforcement Learning from Human Feedback (RLHF) with Reinforcement Learning from AI Feedback (RLAIF).

17. The system of claim 1, wherein refining the AI model comprises automatically restructuring a vector index for the multi-dimensional vector representations.

18. The method of claim 11, further comprising:
prioritizing, by the computing device, the security alert, based on (i) a potential impact of the potential security threat on an organization that operates the security network, and (ii) a detection confidence that corresponds to a likelihood that the security alert is not a false positive or a false negative and (iii) the potential lateral movement paths available to the threat actor based on network topology analysis.

19. The method of claim 11, wherein collecting the real-time telemetry data comprises:
receiving the real-time telemetry data through multiple different security threat feeds, each security threat feed having a different data format; and
outputting the real-time data in a common schema with standardized metadata tagging for cross-correlation across different data sources.

20. The method of claim 11, further comprising:
in response to the security alert being an indicator of attack, issuing a ticket that corresponds to the actual security threat, by a ticketing system that is integrated with the cybersecurity threat detection and mitigation system; and
automatically assigning the ticket to an appropriate security team based on a threat classification and team expertise.
